(19) United States
(12) Patent Application Publication
(10) Pub. No.: US 2011/0260024 A1
(43) Pub. Date: Oct. 27, 2011

(54) STRUCTURE FOR POSITIONING OPERATING UNIT

(75) Inventors: Toshimichi Oosawa, Gumma (JP); Katsuhiro Sawanaka, Gumma (JP)

(73) Assignee: OKI ELECTRIC INDUSTRY CO., LTD., Tokyo (JP)

(21) Appl. No.: 13/063,712

(22) PCT Filed: Jul. 5, 2010
(86) PCT No.: PCT/JP2010/061421

§ 371 Date: Mar. 11, 2011

(30) Foreign Application Priority Data
Sep. 23, 2009 (JP) 2009-218323

(51) Int. Cl. F16M 13/02

(52) U.S. Cl. 248/222.14

(57) ABSTRACT

A positioning structure, which fixes an operating unit (1) by a fixing bracket (4) and an adjusting bracket (2) provided with stoppers (3), easily performs the positioning that prevents the positions of the stoppers (3) from being displaced due to a customer's pressing force acted to the operating unit (1). Inclined rectangular holes (6) are formed at the adjusting bracket (2), and the adjusting bracket is fixable after fastening positions of fixing screws (5) are adjusted along the rectangular holes (6). Alternatively, step shaped rectangular holes (16) are formed, and the adjusting bracket is fixable after fastening positions of the fixing screws 5 are adjusted along the rectangular holes (16).

### TECHNICAL FIELD

The present invention relates to a structure for positioning an operating unit of an automatic transaction machine such as an automated teller machine (hereinafter, referred to as “ATM”).

### BACKGROUND TECHNOLOGY

An operating unit, which is to be operated by a customer, of an ATM includes a display unit and a touch panel. Further, in order to improve the detection accuracy of the touch panel, the touch panel and the display unit need to be disposed with no gap therebetween and need to be fixed to a main body of the ATM after the positions of the touch panel and the display unit are adjusted so as not to interfere with a front cover. A structure related to the position adjustment has been proposed (for example, see Patent Document 1 (Japanese Patent Application Laid-Open (JP-A) No. 7-230567)).

Further, in order to obtain a reaction force when a customer presses the touch panel, it is preferable that the back side of the operating unit be further pressed by stoppers.

Conventionally, the positioning structure has a configuration shown in FIG. 4. That is, an adjusting bracket 102 and stoppers 103a and 103b mounted on the adjusting bracket are disposed on the back side of an operating unit 101 in order to obtain a reaction force against the pressing of a customer in a direction of an arrow A.

Further, the adjusting bracket 102 is configured to be fixable to a fixing bracket 104 by fixing screws 105a and 105b that are mounted in rectangular holes 106a and 106b.

Furthermore, in order to position the operating unit 101 and the stoppers 103a and 103b, the fixing screws 105a and 105b are fixed to the fixing bracket 104 after the fastening positions of the fixing screws are adjusted in a direction of an arrow B along the rectangular holes 106a and 106b formed at the adjusting bracket 102.

### DISCLOSURE OF THE INVENTION

### Problems To Be Solved By the Invention

However, in the above-mentioned conventional structure for positioning the operating unit, which acts as a holding force with respect to the customer's pressing force is only a holding force which is caused by a tightening force between the fixing bracket 104 and the fixing screws 105 for positioning the adjusting bracket 102. For this reason, there is a problem in that the positioning between the operating unit 101 and the stoppers 103 is displaced, when an external force equal to or larger than the tightening force is applied to the operating unit 101.

### Means For Solving the Problems

The invention employs the following configuration in order to solve the above-mentioned problems. That is, in a positioning structure that fixes an operating unit by a fixing bracket and an adjusting bracket provided with stoppers, inclined rectangular holes are formed in the adjusting bracket, and the adjusting bracket is fixable after fastening positions of fixing screws are adjusted along the rectangular holes.

### Effects of the Invention

According to the structure for positioning an operating unit of the invention, the positioning structure, wherein the operating unit is fixed by the fixing bracket and the adjusting bracket provided with the stoppers, is used. Further, the inclined rectangular holes are formed at the adjusting bracket, and the adjusting bracket is fixable after the fastening positions of the fixing screws are adjusted along the rectangular holes. For this reason, a necessary fixing force due to the tightening of the fixing screws can be reduced, and a proof stress for holding a positioning can be increased.

### BRIEF DESCRIPTION OF THE DRAWINGS

FIG. 1A is a view showing the configuration of a structure for positioning an operating unit according to a first embodiment.

FIG. 1B is a view showing the configuration of the structure for positioning an operating unit according to the first embodiment.

FIG. 1C is a view showing the configuration of the structure for positioning an operating unit according to the first embodiment.

FIG. 2 is a view showing the configuration of a structure for positioning an operating unit according to a second embodiment.

FIG. 3 is a view showing the configuration of a structure for positioning an operating unit according to a third embodiment.

FIG. 4A is a view showing the configuration of a conventional structure for positioning an operating unit.

FIG. 4B is a view showing the configuration of the conventional structure for positioning an operating unit.

### Preferred Forms For Embodying the Invention

Embodiments related to the invention will be described below with reference to the drawings. Elements common to the drawings are denoted by the same references.

### First Embodiment

### Configuration

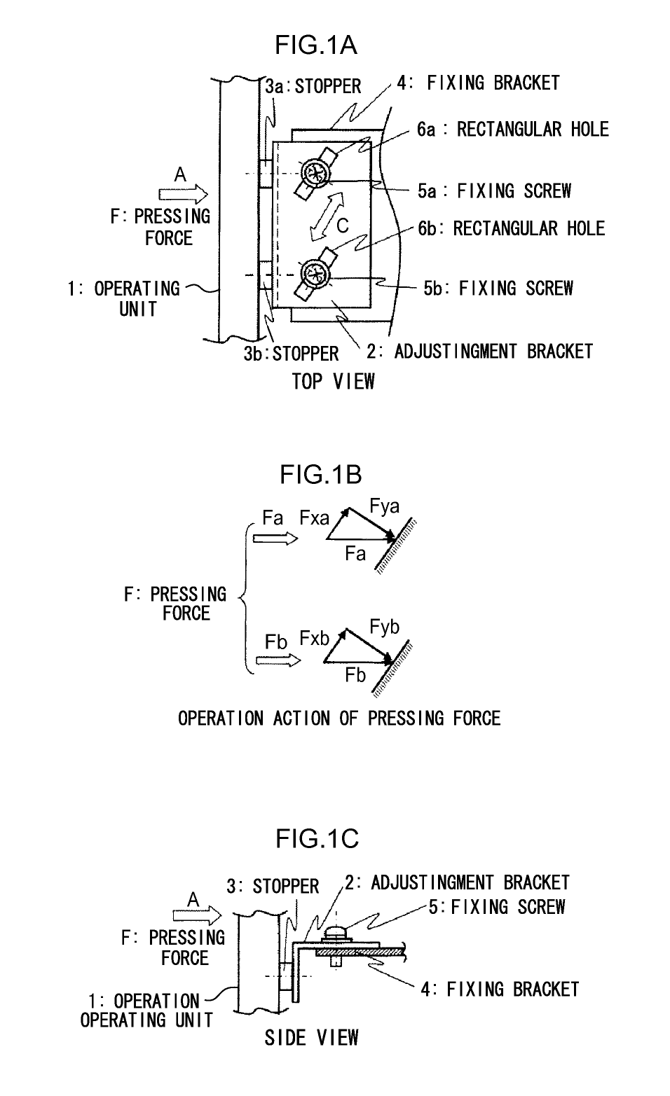

FIG. 1 is a view showing the configuration of a structure for positioning an operating unit according to a first embodiment, FIG. 1A is a top view of the structure for positioning an operating unit according to the first embodiment, and FIG. 1B is a side view of the structure.

As shown in FIGS. 1A and 1B, in the structure for positioning an operating unit according to the first embodiment, an adjusting bracket 2 and stoppers 3a and 3b mounted on the adjusting bracket are disposed on the back side of an operating unit 1 in order to obtain a reaction force against the pressing of a customer in a direction of an arrow A.

Further, inclined rectangular holes 6a and 6b are formed at the adjusting bracket 2, and the adjusting bracket is configured to be fixable to a fixing bracket 4 by fixing screws 5a and 5b that are mounted in the rectangular holes 6a and 6b.

### Operation

The structure for positioning an operating unit according to the first embodiment having the above-mentioned configuration is operated as follows. The operation of the structure will be described with reference to FIG. 1.

In the structure for positioning an operating unit according to the first embodiment, first, the adjusting bracket 2 is assembled as being temporarily fixed by the fixing screws 5 with a small gap between the operating unit 1 and the stoppers 3 mounted on the adjusting bracket 2. Subsequently, the fastening positions of the fixing screws 5 are adjusted in a direction of an arrow C along the inclined rectangular holes 6 that are formed at the adjusting bracket 2. Further, the stoppers 3 are abutted against the operating unit 1 and the fixing screws 5 are tightened so that the adjusting bracket 2 is fixed.

Then, as shown in FIG. 1C, forces Fa and Fb are respectively generated to the fixing screws 5a and 5b due to a customer's pressing force F shown as the arrow A. However, since the rectangular holes 6 are inclined, the forces Fa and Fb are decomposed into forces parallel to the surface and forces vertical to the surface, that is, forces Fxa and Fya and forces Fxb and Fyb, respectively. Further, the normal forces Fya and Fyb are cancelled due to the abutment between the fixing screws 5a and 5b and the rectangular holes 6, and only the forces Fxa and Fxb are held by the fixing screws 5. For this reason, the proof stress for holding the fixing positions due to the fixing screws 5 is increased as compared to the conventional structure for positioning an operating unit.

### Effects of First Embodiment

According to the structure for positioning an operating unit of the first embodiment as described in detail above, the positioning structure, which fixes the operating unit by the fixing bracket and the adjusting bracket provided with the stoppers, is used. Further, the inclined rectangular holes are formed at the adjusting bracket, and the adjusting bracket is fixable after the fastening positions of the fixing screws are adjusted along the rectangular holes. For this reason, a necessary fixing force due to the tightening of the fixing screws can be reduced and a proof stress for holding a positioning can be increased.

### Second Embodiment

### Configuration

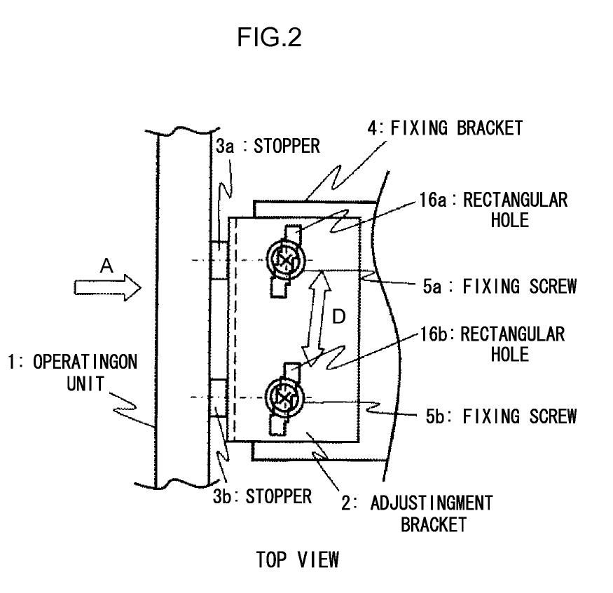

FIG. 2 is a view showing the configuration of a structure for positioning an operating unit according to a second embodiment. Meanwhile, since the side view of the structure for positioning an operating unit according to the second embodiment is the same as in FIG. 1B that has been used in the first embodiment, the description thereof is omitted for simplification.

As shown in FIG. 2, in the structure for positioning an operating unit according to the second embodiment, an adjusting bracket 2 and stoppers 3a and 3b mounted on the adjusting bracket are disposed on the back side of an operating unit 1 in order to obtain a reaction force against the pressing of a customer in a direction of an arrow A.

Further, step shaped rectangular holes 16a and 16b are formed at the adjusting bracket 2. Furthermore, the adjusting bracket is configured to be fixable to a fixing bracket 4 by fixing screws 5a and 5b that are mounted in the rectangular holes 16a and 16b.

### Operation

The structure for positioning an operating unit according to the second embodiment having the above-mentioned configuration is operated as follows. A description is to be given below with reference to FIG. 2.

In the structure for positioning an operating unit according to the second embodiment, first, the adjusting bracket 2 is assembled as being temporarily fixed by the fixing screws 5 with a small gap between the operating unit 1 and the stoppers 3 mounted on the adjusting bracket 2. Subsequently, the fastening positions of the fixing screws 5 are adjusted in a direction of an arrow D along the step shaped rectangular holes 16 that are formed at the adjusting bracket 2. Further, the stoppers 3 are abutted against the operating unit 1 and the fixing screws 5 are tightened so that the adjusting bracket 2 is fixed.

Then, forces Fa and Fb are respectively generated to the fixing screws 5a and 5b due to a customer's pressing force F shown as the arrow A. However, since the rectangular holes 16 are step shaped, the external forces Fa and Fb are vertically acted to the stepped surfaces of the rectangular holes 16. For this reason, the fixing screws 5 themselves function as stop members, so that it may be possible to reliably hold the positions fixed by the fixing screws 5.

Meanwhile, the stepped shape may correspond to the sizes of the fixing screws, and may be formed so that the diameter of a thread portion of the fixing screw is substantially equal to the length of one step.

### Effects of Second Embodiment

According to the structure for positioning an operating unit of the second embodiment as described in detail above, the step shaped rectangular holes are formed at the adjusting bracket. Further, the adjusting bracket is fixable after the fastening positions of the fixing screws are adjusted along the rectangular holes. For this reason, it may be possible to further increase a proof stress that holds a positioning.

### Third Embodiment

### Configuration

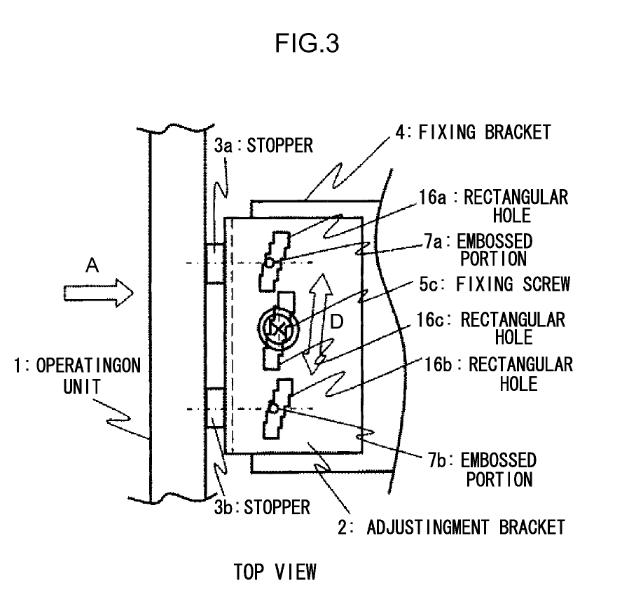

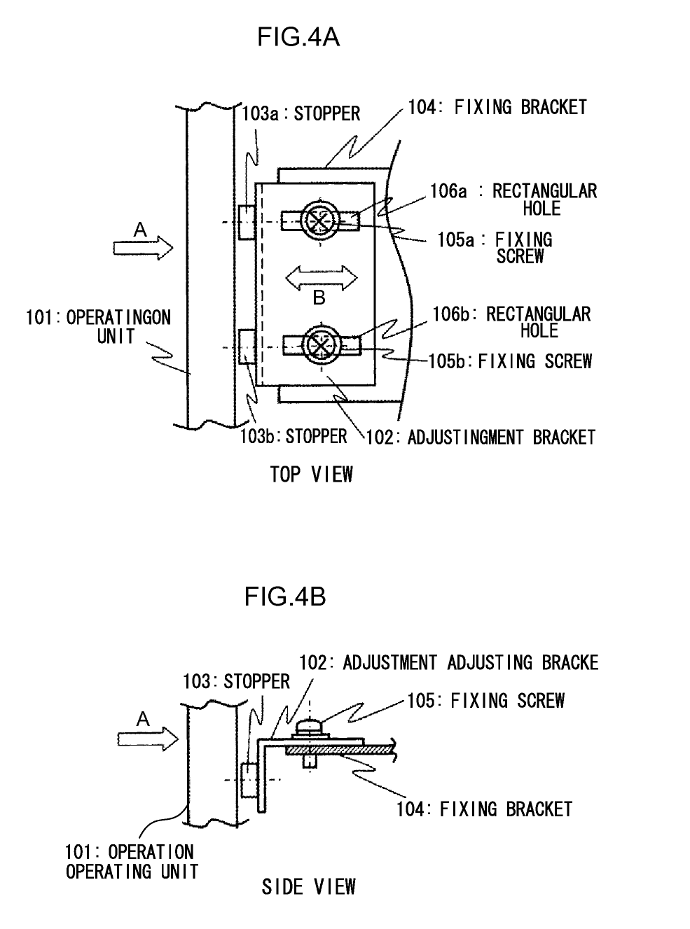

FIG. 3 is a view showing the configuration of a structure for positioning an operating unit according to a third embodiment. Meanwhile, since the side view of the structure for positioning an operating unit according to the third embodiment is the same as in FIG. 1B that has been used in the first embodiment, the description thereof is omitted for simplification.

As shown in FIG. 3, in the structure for positioning an operating unit according to the third embodiment, an adjusting bracket 2 and stoppers 3a and 3b mounted on the adjusting bracket are disposed on the back side of an operating unit 1 in order to obtain a reaction force against the pressing of a customer in a direction of an arrow A.

Further, step shaped rectangular holes 16a to 16c are formed at the adjusting bracket 2. Furthermore, embossed portions 7a and 7b are provided on a fixing bracket 4 at the positions of the rectangular holes 16a and 16b. Moreover, the adjusting bracket 2 is configured to be fixable to the fixing bracket 4 by a fixing screw 5c that is mounted in the rectangular hole 16c of the adjusting bracket 2.

### Operation

The structure for positioning an operating unit according to the third embodiment having the above-mentioned configuration is operated as follows. A description is to be given below with reference to FIG. 3.

In the structure for positioning an operating unit according to the third embodiment, first, the adjusting bracket 2 is assembled as being temporarily fixed by the fixing screw 5c with a small gap between the operating unit 1 and the stoppers 3a and 3b mounted on the adjusting bracket 2. Subsequently, the embossed portions 7a and 7b are moved in a direction of an arrow D along the step shaped rectangular holes 16a and 16b that are formed at the adjusting bracket 2. Further, the stoppers 3 are abutted against the operating unit 1 and the fixing screw 5c is tightened so that the adjusting bracket 2 is fixed.

Then, forces Fa and Fb are respectively generated to the embossed portions 7a and 7b due to a customer's pressing force F shown as the arrow A. However, since the rectangular holes 16 are step shaped, the external forces Fa and Fb are vertically acted to the stepped surfaces of the rectangular holes 16. For this reason, the embossed portions 7a and 7b function as stop members, so that it may be possible to fix the adjusting bracket without an external force being acted to the fixing screw 5. Meanwhile, the stepped shape may be formed so that the diameter of the embossed portion is substantially equal to the length of one step.

In the above description, it has bee described that two embossed portions and one fixing screw are provided. However, more embossed portions and more fixing screws may be provided.

### Effects of Third Embodiment

According to the structure for positioning an operating unit of the third embodiment as described in detail above, the step shaped rectangular holes are formed at the adjusting bracket. Further, the embossed portions are provided on the fixing bracket, and the adjusting bracket is fixable by the fixing screw after the positions of the embossed portions are adjusted along the rectangular holes. For this reason, it may be possible to reduce the force acted to the fixing screw, so that it may also be possible to prevent the breakage of the fixing screw.

### INDUSTRIAL APPLICABILITY

As described above, the invention may be widely used for an automatic transaction machine such as an automated teller machine that needs to position an operating unit.

### EXPLANATION OF REFERENCES

1: operating unit

2: adjusting bracket

3, 3a, 3b: stopper

4: fixing bracket

5, 5a to 5c: fixing screw

6, 6a, 6b, 16, 16a to 16c: rectangular hole

7, 7a, 7b: embossed portion

What is claimed is:

1. A structure for positioning an operating unit, comprising:
a fixing bracket; and
an adjusting bracket provided with stoppers,
wherein inclined rectangular holes are formed at the adjusting bracket, and the adjusting bracket is fixable after fastening positions of fixing screws are adjusted along the rectangular holes.

2. The structure for positioning an operating unit according to claim 1, wherein the inclined rectangular holes are step shaped rectangular holes, and the adjusting bracket is fixable after the fastening positions of the fixing screws are adjusted along the rectangular holes.

3. The structure for positioning an operating unit according to claim 1, wherein the inclined rectangular holes are step shaped rectangular holes, embossed portions are formed at the fixing bracket, and the adjusting bracket is fixable by a fixing screw after positions of the embossed portions are adjusted along the rectangular holes.
